(19) United States
(12) Patent Application Publication
(10) Pub. No.: US 2005/0274754 A1
(43) Pub. Date: Dec. 15, 2005

(54) Rucksack comprising an intergrated child seat

(76) Inventor: Stephan Buffinton, Augsburg (DE)

Correspondence Address: THE LAW FIRM OF HARRIS & BURDICK;HAROLD BURDICK AND ROBERT HARRIS, 6676 GUNPARK DRIVE, SUITE E, BOULDER, CO, 80301, US

(21) Appl. No.: 10/516,251

(22) PCT Filed: May 28, 2003
(86) PCT No.: PCT/DE03/01777

§ 371 Date: Nov. 29, 2004

(30) Foreign Application Priority Data
Jun. 3, 2002 (DE) 102 24 655.6

(51) Int. Cl. A45F 4/02; A61G 1/00

(52) U.S. Cl. 224/155; 224/160

(57) ABSTRACT

The invention concerns a rucksack which is divided into 2 sections (31, 32), they can be connected along a line (7) and can be hinged open. When opened they provide a space where an infant can be placed.

Rucksacks with integrated seats are known.

For example the U.S. Pat. No. 4,795,068 deals with a rucksack frame that can be changed into a seat, from the original carrier frame a brace can be folded out and the shoulder belt is stretched over said brace. From the U.S. Pat. No. 5,588,570 another rucksack is known, which exhibits on the side facing the rucksack strap a fold out, pillow shaped seat.

The role of the invention at hand is to manufacture a rucksack that can be very simply converted into a carrying device for infants without the aid of additional parts.

The task has been solved with a rucksack with the characteristics of patent claim 1.

The essential advantage lies in the fact that the rucksack at hand can be changed into a carrying device for infants without additional frame parts or additional seating elements. Therefore you only need to hinge the rucksack open around the dividing line on the circumference, the infant can be seated between the two opened parts of the carrier bag. Falling out of the sides is prevented by holding elements on the sides. Vents and spaces are intended through which the feet of the infant are guided outside.

Several advantageous embodiments of the invention are clear through sub claims:

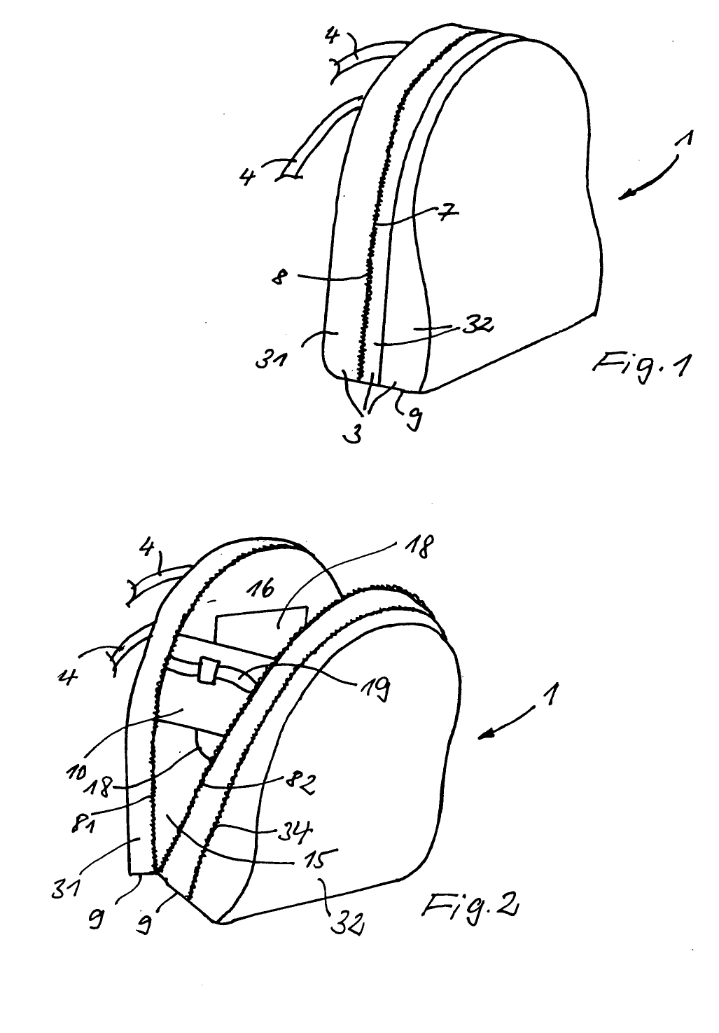

FIG. 1 schematic illustration of the invented rucksack while closed

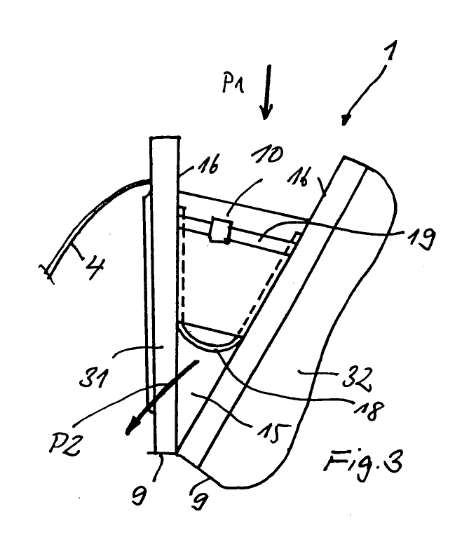

FIG. 2 schematic illustration of the invented rucksack while opened and

FIG. 3 continued advancement of the invention

In FIG. 1 the rucksack at hand is titled 1.

It has the usual pack sack 3 that is attached to the carrier frame. The shoulder straps of rucksack 1 are labelled 4. We like to point out that in relation to the invention at hand the particular design of the carrier frame, the shoulder straps 4, the packsack 3 and when required hip straps do not matter. The invention can be used in combination with different types of rucksacks.

The packsack 3 of the rucksack at hand 1 consists in general of 2 sections 31, 32 that are connected along a line 7 which runs parallel to the wall of the rucksack 1 facing the rucksack wearer.

Preferably line 7 is created by a surrounding sliding fastener 8, which runs on the side of the rucksack 1, starting from the base 9 around rucksack 1 upwards to the opposite side of the rucksack until near the base part 9.

By opening the surrounding sliding fastener 8 the side parts 10 fastened to the ends of the packsack sections 31, 32 can be folded open and hold the two packsack parts 31, 32 together even when they are completely opened. In FIG. 2 the two matching parts of the surrounding sliding fastener 8 are labelled 81 and 82.

The side parts 10 have spaces or gaps on the sides above the base 9, so that the feet of the infant can be put through them.

The side parts 10 can also be replaced by the straps 19 or similar, which are fastened to the packsack sections 31, 32 and run at right angle to the rear wall of the rucksack facing the straps, but the spaces 15 remain under the straps 19.

The straps 19 can also be used to adjust the width of the opening between the sections 31, 32, as they are adjustable lengthwise. This guarantees that adjustments can be made according to the different sizes of infants.

In particular it is possible to combine the side parts and the adjustable straps 19, so that the opening width can be reduced to less than the maximum which is controlled by the side parts 10.

Instead of the preferred surrounding sliding fastener 8 for closing the packsack parts 31, 32 along the line 7 any other closing devices can be used, e.g. Velcro fastener elements, push-button elements or straps, etc.

After opening the rucksack 1 as shown in FIG. 2 the infant is lowered in from above between the side parts 10 and the opening between the sections 31, 32 (arrow P1). The legs of the infant are guided through the openings 15 along the arrow P2 to the outside.

Each section 31, 32 can be closed through a wall 16 on the opposite side facing the other pack bag and can be packed via a not further indicated or illustrated opening.

Section 31 in particular forms a comfortable back rest for the infant to lean on.

Especially favoured is the construction in which the pack bag part 31—facing the shoulder straps—is used and constructed as padding for the wearer and as a soft padding device for the back of the infant. The inside of the section 31 can be reinforced through the known frame construction.

The section 32 facing away from the rucksack wearer can be made especially accessible with an additional surrounding sliding fastener 34. An additional benefit is that the carried infant has easy access for example to a baby bottle or baby clothing or other items.

To give the infant a good and secure hold, one of the favoured designs of the invention features a padded carrier and hold strap 18 between the sections of the pack bag. It runs between the legs of the infant, and holds the infant securely and comfortably in place. This is illustrated in FIG. 3.

1. A rucksack comprising:
a bag divided into at least first and second sections releasably connectable so that said sections can selectively be hinged, open when in an unconnected state and secured together when in a connected state;
a shoulder strap structure associated with said first section of said bag for user carriage of said bag;
at least one holding element secured to said first and second sections of said bag for restraining further opening beyond a maximum opened position when said section are hinged open; and
whereas said maximum opened position of said first and second sections of said bag when in said unconnected state is selected to accommodate seating of a child within said bag.

2. The rucksack of claim 1 wherein said first and second sections of said bag are releasable connectable along an edge of each of said sections running parallel to a side of said first section of said bag oriented to face a user carrying said rucksack said rucksack further comprising a base one of associated with said first and second sections or defined by said first and second sections, said edges of said first and second sections of said bag defined from a starting point near one the side of the said base to an opposing point near an opposite side of said base.

3. The rucksack of claim 1 further comprising a sliding fastener system associated with said first and second sections of said bag for selective opening and securing closed said bag.

4. The rucksack of claim 1 further comprising a second holding element secured to said first and second sections of said bag at a location spaced from said at least one holding element.

5. The rucksack of claim 4 wherein said holding elements are attached between said sections of said bag so that spaced substantially triangular openings are defined by each of said holding elements and said first and second sections of said bag when said sections are hinged open, thereby to receive each leg of a child when seated in said bag through different ones of said triangular openings through them.

6. The rucksack of claim 1 wherein said holding element includes adjustment means for selectively establishing extent of said maximum opened position.

7. The rucksack of claim 1 further comprising carriage means connected between said first and second sections at an interior portion of said bag for secure seating of a child therein.

8. A rucksack configured to accommodate carriage of a child therein comprising:
a bag divided into at least first and second sections and having a base one of associated with said first and second sections or defined by said first and second sections, said first and second sections releasably connectable so that said sections can selectively be opened from a location spaced from said base and extending to said base when in an unconnected state and secured together when in a connected state;
a shoulder strap structure associated with said first section of said bag for user carriage of said bag;
first and second side wall parts secured to said first and second sections of said bag for restraining further opening beyond a maximum opened position when said sections are in said unconnected state, said side wall parts configured so that first and second openings are defined between first and second side wall parts, respectively, and said base when said first and second sections of said bag are fully in said unconnected state, said first opening at one side of said bag and said second opening at an opposite side of said bag; and
whereas said maximum opened position of said first and second sections of said bag when fully in said unconnected state is selected to accommodate seating of a child within said bag with each lea of the child extending through a different one of said openings.

9. The rucksack of 8 further comprising a carrier and holding strap connected at said first and second sections of said bag to carry and hold the child when placed within said bag.

10. The rucksack of claim 9 wherein said carrier and holding strap is padded.

11. The rucksack of claim 1 wherein said first section of said bag includes a construction that pads the back of the user when said rucksack is in use and that pads the back of the child when seated within said bag.

12. The rucksack of claim 1 wherein said first section of said bag includes construction for reinforcement thereof.

13. The rucksack of claim 1 wherein said first section of said bag is configured to provide a user accessible interior.

14. The rucksack of claim 1 wherein said second section of said bag in configured to provide an interior portion that is accessible through an opening.

15. The rucksack of claim 9 wherein said first and second sections each have an interior side wall defining in at least one of said sections an interior compartment said side walls facing each other at the interior of said bag and having said carrier and held holding strap extending therebetween.

16. The rucksack of claim 8 wherein said side wall parts include adjustable straps connected adjacent thereto for enabling user adjustment of said maximum opened position.

17. A method for adapting a rucksack for carriage of a child, said rucksack having front and rear bag sections releasably securable at a closure, said method comprising:
establishing a maximum extent of separation of the front and rear bag sections when in a fully opened state;
establishing seating for the child at an interior part of the bag when in said opened state; and
collapsing said seating at said interior part of the bag when the bag is closed and the front and rear sections are secured at said closure.

18. The method of claim 17 wherein the step of establishing a maximum extent of separation of the front and rear bag sections includes making establishment of said maximum extent user adjustable.

19. The method of claim 17 wherein the step of establishing seating for the child at an interior part of the bag includes accommodating the legs of the child through openings at opposite sides of the bag.

20. The method of claim 19 wherein the step of establishing seating for the child at an interior part of the bag includes elevating the child at said interior part relative to a base portion of the bag.
